(19) United States
(12) Patent Application Publication
(10) Pub. No.: US 2010/0059981 A1
(43) Pub. Date: Mar. 11, 2010

(54) SHIELD FOR WEIGHT GUAGE BOX

(76) Inventor: Gerald Theesfeld, Curlew, IA (US)

Correspondence Address: DAVIS, BROWN, KOEHN, SHORS & ROBERTS, P.C.;THE DAVIS BROWN TOWER, 215 10TH STREET SUITE 1300, DES MOINES, IA, 50309, US

(21) Appl. No.: 12/556,949

(22) Filed: Sep. 10, 2009

Related U.S. Application Data
(60) Provisional application No. 61/095,737, filed on Sep. 10, 2008.

(51) Int. Cl. B62D 25/18

(52) U.S. Cl. 280/848

(57) ABSTRACT

A shield for a component, such as a weight gauge box, of a tractor trailer is described. The shield includes a bracket for mounting of a shield member, such as a heavy rubber mud flap, that mounts the flap rearward of the component and forward of wheels of the tractor trailer. The shield limits the likelihood of damage to the component by impact from an object thrown by the wheels and also limits the deposit of road dirt and grime thrown by the wheels.

This application claims priority to U.S. patent application Ser. No. 61/095,737, filed Sep. 10, 2008.

### BACKGROUND OF THE INVENTION

The invention relates generally to tractor trailers and, more specifically, to a shield or mud flap for a weight gauge box mounted forward of wheels of a tractor trailer.

Weight gauges are in common use on trailers towed by semi-tractors. Most such trailers are equipped with an air spring suspension system. Proper use of the air spring system requires adjustment of the pneumatic pressure systems in response to changes in the weight of the load being carried by the tractor trailer. The controls for these systems have to be accessible to operators and are frequently located in a box mounted on the side of the tractor trailer forward of the rear wheels of the trailer. To gain access to the controls for needed adjustments to the system, the operator opens a door on the box, makes the adjustment, and then closes and secures the door. The rear wheels of the trailer throw dirt, water, mud and other road debris toward the box as the trailer is driven down the road so that the box is subject to damage in addition to be dirty or possible coated in mud that prevents easy access to the controls by the operator.

A method is needed to limit the likelihood of damage to the weight gauge box and to reduce the amount of dirt, mud and other road debris that is deposited on the weight gauge box.

### SUMMARY OF THE INVENTION

The present invention consists of a shield, preferably in the form or an elastomeric flap, mounted on a tractor trailer between a component, such as a weight gauge box, and the wheels of the tractor trailer. The shield limits the amount of road debris that impacts and may be deposited on the component. While such shields or mud flaps are known for use behind the wheels of a tractor trailer to limit throwing of road debris onto trailing or adjacent vehicles, no previous application of such shields forwardly of the wheels is known.

### BRIEF DESCRIPTION OF THE FIGURES

FIG. 1 is a side view of a tractor trailer showing a weight gauge box mounted on the side of the trailer below the bed and forward of wheels of the trailer.

FIG. 2 is a rear perspective view corresponding to FIG. 1.

FIG. 3 if a perspective view of a preferred embodiment of a shield of the present invention.

FIG. 4 is a side view of the shield of FIG. 3 mounted on the tractor trailer with the flap rearward of the weight gauge box.

FIG. 5 is a rear view showing how the shield of the present invention protects the weight gauge box.

### DETAILED DESCRIPTION OF THE INVENTION

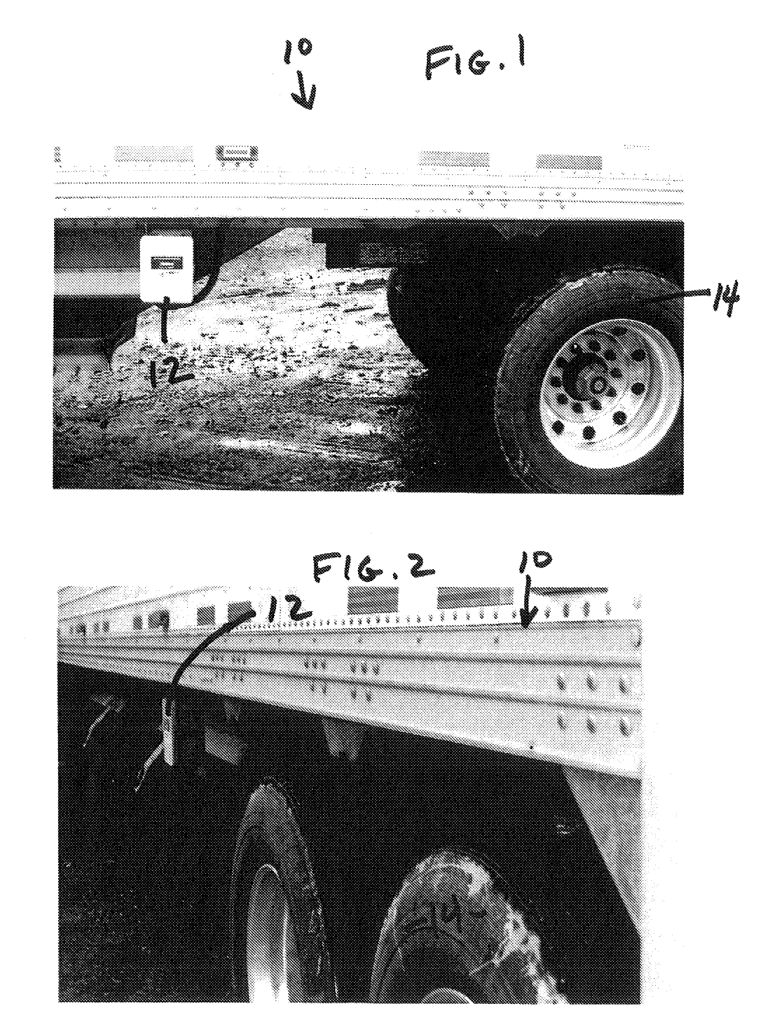

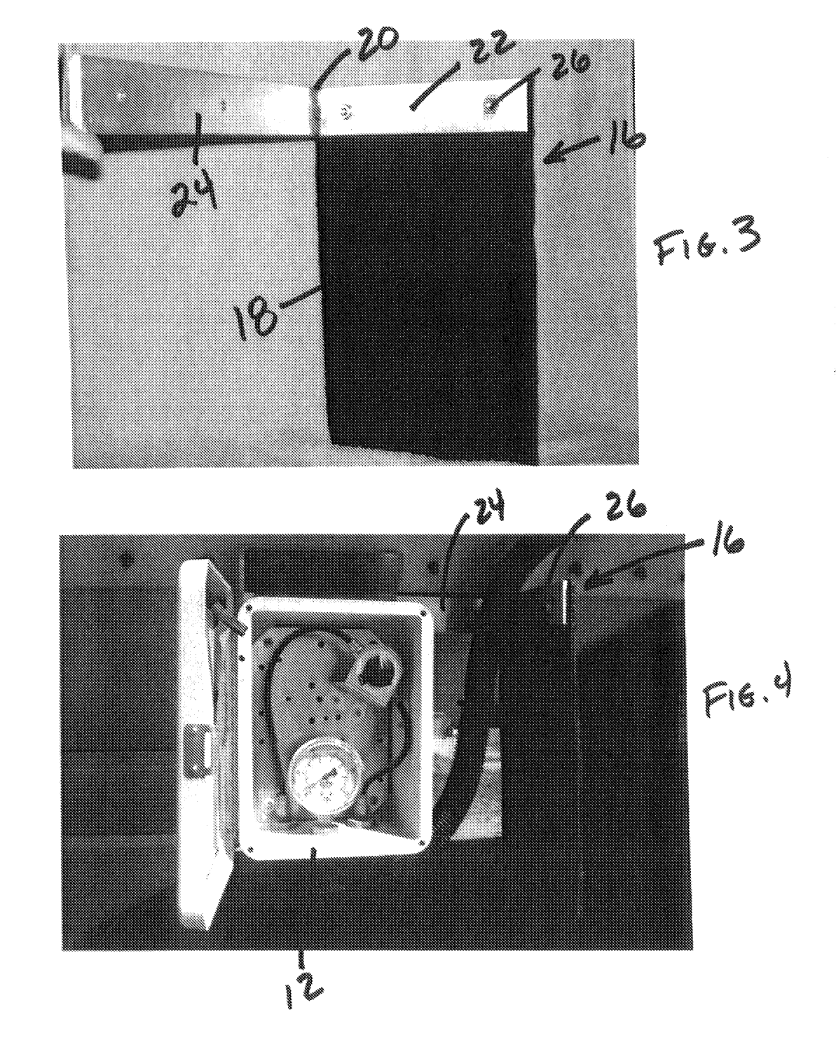

Illustrated in FIGS. 1 and 2, generally at 10, is a tractor trailer on which is mounted a weight gauge box 12 in common use to control the air spring suspension system of the tractor trailer 10. The weight gauge box 12 is mounted forwardly of the wheels 14 of the tractor trailer 10.

In a preferred embodiment of the invention, a shield 16 is constructed of an L-shaped bracket 20, having a flap mounting arm 22 and a trailer mounting arm 24 (FIG. 3). The shield 16 also includes a sheet 18, which in the preferred embodiment is made of an elastomeric material, such as a heavy rubber sheet. The sheet 18 is attached to the flap mounting arm 22. In the preferred embodiment, a pair of nut and bolt combinations 26 are used to attach the upper end portion the sheet 18 to the arm 22 so that the sheet 18 is free to flex relative to the arm 22, although many other methods of attachment are known to those skilled in the art.

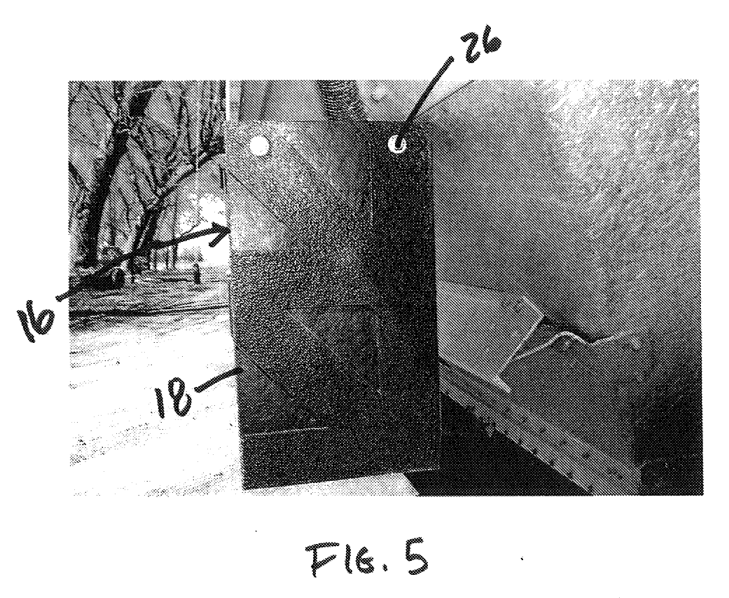

The shield 16 is mounted on the trailer 10 between the weight gauge box 12 and the wheels 14 (FIG. 4). The size and shape of the sheet 18 and the mounting position of the shield 16 are selected to prevent or limit road debris or grime thrown up by the wheels 14 from impacting the weight gauge box 12, thus protecting the weight gauge box and limiting the amount of dirt and grime deposited on the weight gauge box 12 (FIG. 5). While an elastomeric material is used for the sheet 18 in the preferred embodiment, any material that will act to prevent or limit road debris, dirt or grime thrown up by the wheels 14 from impacting the weight gauge box 12 will also work.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

I claim:

1. A shield for protecting a component attached to a tractor trailer forwardly of a wheel of the tractor trailer, comprising:
(a) a mounting bracket;
(b) a shield member attached to the mounting bracket; and
(c) structure mounting the mounting bracket on the tractor trailer rearwardly of the component and forwardly of the wheel in a position to limit the impact or deposit on the component and road debris or grime thrown by the wheel.

2. A shield as defined in claim 1, wherein the shield member hangs below the mounting bracket.
